(19) United States
(12) Patent Application Publication
(10) Pub. No.: US 2011/0305437 A1
(43) Pub. Date: Dec. 15, 2011

(54) ELECTRONIC APPARATUS AND INDEXING CONTROL METHOD

(75) Inventors: Tomonori Sakaguchi, Ome-shi (JP); Kouetsu Wada, Nishitama-gun (JP); Kohei Momosaki, Mitaka-shi (JP); Kenichi Tabe, Ome-shi (JP); Shunsuke Takayama, Tachikawa-shi (JP)

(73) Assignee: KABUSHIKI KAISHA TOSHIBA, Tokyo (JP)

(21) Appl. No.: 13/161,393

(22) Filed: Jun. 15, 2011

(30) Foreign Application Priority Data
Jun. 15, 2010 (JP) 2010-136535

(51) Int. Cl. H04N 5/93

(52) U.S. Cl. 386/278; 386/E05.003

(57) ABSTRACT

According to one embodiment, an electronic apparatus includes an indexer, a photomovie processor and an indexing controller. The indexer is configured to generate index information about still images. The photomovie processor is configured to generate a photomovie constituted by the still images based on the index information, and to display the generated photomovie. The indexing controller is configured to monitor whether new still images are added, about which the indexer should generate the index information, to cause the photomovie processor to start displaying of a slide show displaying new still images one after another and cause the indexer to start generating of the index information about the new still images, when the new still images are added.

### CROSS-REFERENCE TO RELATED APPLICATIONS

This application is based upon and claims the benefit of priority from Japanese Patent Application No. 2010-136535, filed Jun. 15, 2010; the entire contents of which are incorporated herein by reference.

### FIELD

Embodiments described herein relate generally to an electronic apparatus which executes indexing of still images and an indexing control method of the electronic apparatus.

### BACKGROUND

In recent years, the resolution of any imaging element such as a charge coupled device (CCD) or a complementary metal-oxide semiconductor (CMOS) image sensor has increased. Along with this technical trend, the resolution has been increased for still images processed by electronic apparatuses such as mobile telephones and personal computers.

Recently, image playback apparatuses called “digital photo frames” have come into use in increasing numbers. The digital photo frame includes the function of displaying still images stored in, for example, a card-shaped storage medium, one after another at prescribed intervals. Like the digital photo frame, most personal computers and most digital cameras include the function of displaying still images one after another at prescribed intervals. The way the digital photo frame displays still images is called, for example, “slide show display.”

Further, a moving-picture generating technique that enables the viewer to enjoy seeing still images (or only one still image) in a more enjoyable way is now attracting attention. This technique resides in adding various effects to still images and then editing the still images, thereby generating a moving picture. The moving picture thus generated is called a “photomovie,” for example. The above-mentioned slide show display can be performed not only by sequentially displaying still images at the prescribed intervals, but also by playing back a moving picture generated by the moving-picture generating technique. The moving picture (i.e., photomovie) generated for use in the slide show display is called a “slide show,” too.

To enable the viewer to enjoy slide shows or photomovies, it is necessary to designate the still images to be used or the folder holding these still images. Such designation must be performed, too, to enable the viewer to enjoy seeing still images acquired from a digital camera, for example, in the form of a slide show or a photomovie.

In order to generate a photomovie from still images, the still images must be indexed, generating index information that will be used to extract face images, etc., from the still images. Hence, the photomovie cannot be generated until all still images acquired anew are indexed.

Hitherto, much time is needed to designate the new still images acquired or the folder holding these still images, and a photomovie cannot be generated until all still images are indexed. This cannot meet the demand of the viewer, who wants to enjoy a slide show or a photomovie, with least labor, immediately after new still images have been acquired.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the outer appearance of an electronic apparatus according to an embodiment.

FIG. 2 is an exemplary diagram showing the system configuration of the electronic apparatus according to the embodiment.

FIG. 3 is an exemplary block diagram showing the function configuration of the photomovie creation application program executed by the electronic apparatus according to the embodiment.

FIG. 4 is an exemplary diagram showing exemplary index information used in the photomovie creation application program executed by the electronic apparatus according to the embodiment.

FIG. 5 is an exemplary diagram showing an example main menu screen that may be displayed by the electronic apparatus according to the embodiment.

FIG. 6 is an exemplary diagram showing an example main-character selection screen that may be displayed by the electronic apparatus according to the embodiment.

FIG. 7 is an exemplary diagram showing an example calendar screen that may be displayed by the electronic apparatus according to the embodiment.

FIG. 8 is an exemplary diagram outlining the sequence of photo-movie generating process executed by the electronic apparatus according to the embodiment.

FIG. 9 is an exemplary diagram showing a first example of an image that has some effects applied by the electronic apparatus according to the embodiment.

FIG. 10 is an exemplary diagram showing a second example of an image that has some effects applied by the electronic apparatus according to the embodiment.

FIG. 11 is an exemplary diagram showing a third example of an image that has some effects applied by the electronic apparatus according to the embodiment.

FIG. 12 is an exemplary diagram showing a fourth example of an image that has some effects applied by the electronic apparatus according to the embodiment.

FIG. 13 is an exemplary diagram showing a fifth example of an image that has some effects applied by the electronic apparatus according to the embodiment.

FIG. 14 is an exemplary block diagram showing the function configuration that the photomovie creation application program executed by the electronic apparatus according to the embodiment has in connection with new photos input to the apparatus.

FIG. 15 is an exemplary diagram showing an example of a menu screen that may be displayed by the electronic apparatus according to the embodiment.

FIG. 16 is an exemplary diagram showing an example of a photo-folder menu screen that may be displayed by the electronic apparatus according to the embodiment.

FIG. 17 is an exemplary diagram showing an example of a process menu screen that may be displayed by the electronic apparatus according to the embodiment.

FIG. 18 is an exemplary timing chart showing when various processes are executed after new still images have been stored into a photo folder provided in the electronic apparatus according to the embodiment.

FIG. 19 an exemplary diagram showing an example of an object informing that the slide show is undergoing indexing executed by the electronic apparatus according to the embodiment.

FIG. 20 is an exemplary flowchart showing an example of a process sequence that the electronic apparatus according to the embodiment may execute on the new photos input to it.

FIG. 21 is an exemplary flowchart showing an example of a sequence of the indexing process that the electronic apparatus according to the embodiment executes.

FIG. 22 is an exemplary flowchart showing an example of sequence of the moving-picture generating process that the electronic apparatus according to the embodiment executes.

FIG. 23 is an exemplary flowchart showing an example of a sequence of the key-image selecting process that the electronic apparatus according to the embodiment executes.

FIG. 24 is an exemplary flowchart showing another example of a sequence of the key-image selecting process that the electronic apparatus according to the embodiment executes.

FIG. 25 is an exemplary flowchart showing an example of sequence of the related image selecting process that the electronic apparatus according to the embodiment executes.

### DETAILED DESCRIPTION

Various embodiments will be described hereinafter with reference to the accompanying drawings.

In general, according to one embodiment, an electronic apparatus includes an indexer, a photomovie processor and an indexing controller. The indexer is configured to generate index information about still images. The photomovie processor is configured to generate a photomovie constituted by the still images based on the index information, and to display the generated photomovie. The indexing controller is configured to monitor whether new still images are added, about which the indexer should generate the index information, to cause the photomovie processor to start displaying of a slide show displaying new still images one after another and cause the indexer to start generating of the index information about the new still images, when the new still images are added.

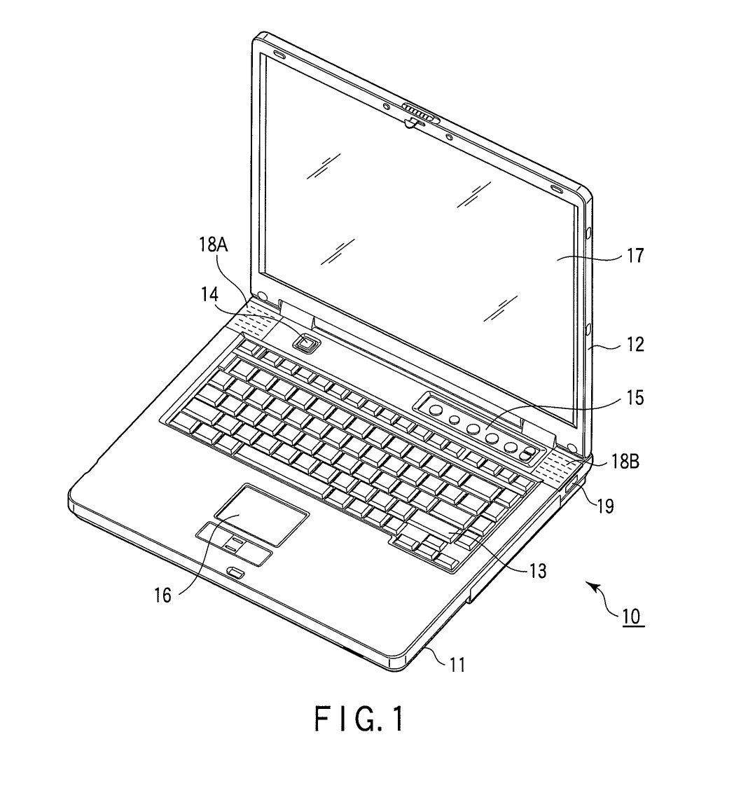

FIG. 1 is an exemplary perspective view showing the outer appearance of the electronic apparatus according to the embodiment. The electronic apparatus is a personal computer 10 of, for example, the notebook type. As shown in FIG. 1, the computer 10 includes a computer main unit 11 and a display unit 12. The display unit 12 incorporates a liquid crystal display (LCD) 17. The display unit 12 is secured to the computer main unit 11 and can rotate between an opened position and a closed position. In the opened position, the display unit 12 exposes the upper surface of the computer main unit 11. In the closed position, the display unit 12 covers the upper surface of the computer main unit 11.

The computer main unit 11 is shaped like a thin box. On its top, a keyboard 13, a power button 14, an input/output panel 15, a touch pad 16 and speakers 18A and 18B are arranged. The power button 14 may be operated to turn on or off the computer 10. The input/output panel 15 includes various buttons.

On the right side of the computer main unit 11, a USB connector 19 is provided, to which an USB cable or a USB device, both according with the universal serial bus (USB)2.0 standards, can be connected.

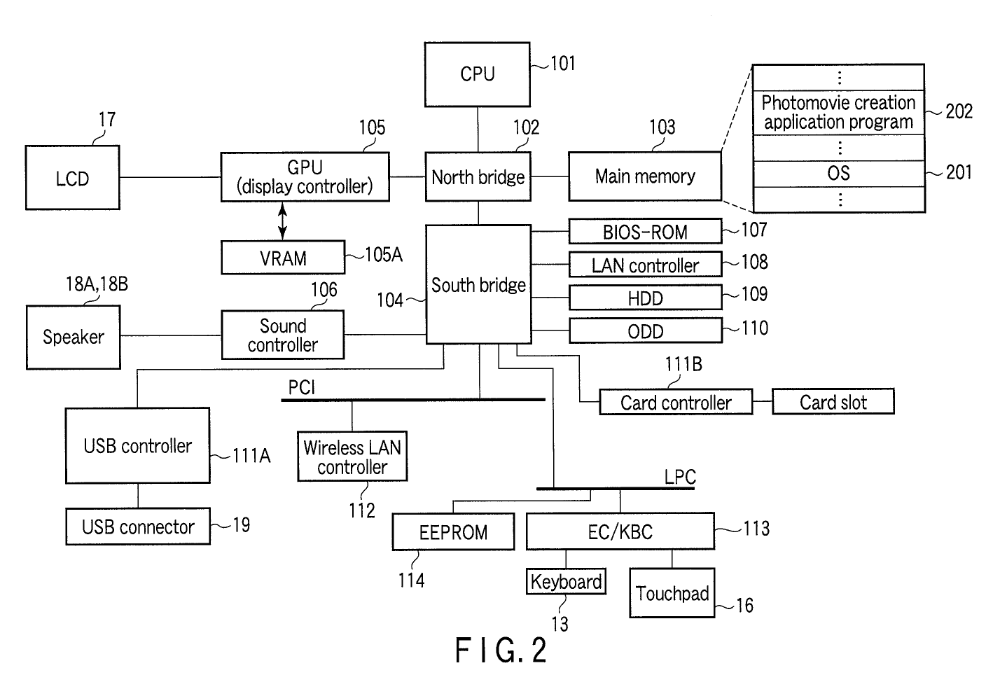

FIG. 2 is an exemplary diagram showing the system configuration of the electronic apparatus 10.

As shown in FIG. 2, the computer 10 includes a central processing unit (CPU) 101, a north bridge 102, a main memory 103, a south bridge 104, and a graphics processing unit (GPU) 105. The computer 10 further includes a video random access memory (VRAM) 106, a sound controller 106, a basic input/output system-read only memory (BIOS-ROM) 107, a local area network (LAN) controller 108, a hard disk drive (HDD) 109, and an optical disc drive (ODD) 110. Still further, the computer 10 includes a USB controller 111A, a card controller 111B, a wireless LAN controller 112, an embedded controller/keyboard controller (EC/KBC) 113, and an electrically erasable programmable ROM (EEPROM) 114. The CPU 101 is the processor that controls the other components of the computer 10. The CPU 10 executes the operating system (OS) 201 and the various application programs, such as a photomovie creation application program 202, all having been loaded from the HDD 109 into the main memory 103. The photomovie creation application program 202 is software that plays back the various digital contents stored in, for example, the HDD 109. The photomovie creation application program 202 includes a moving-picture generating function. This function generates moving pictures (e.g., photomovies and slide shows) by using the digital contents such as photographs, which are stored in, for example, the HDD 109. The moving-picture generating function includes a function of analyzing the digital contents used to generate moving pictures. The photomovie creation application program 202 plays back any moving picture generated from the digital contents, and displays the moving picture so generated to the LCD 17.

The CPU 101 also executes the BIOS stored in the BIOS-ROM 107. The BIOS is a program which controls the hardware components of the computer 10.

The north bridge 102 is a bridge device connecting the local bus of the CPU 101 to the south bridge 104. The north bridge 102 includes a memory controller that controls the main memory 103. The north bridge 102 further includes the function of performing communication with the GPU 105 through, for example, a serial bus of the PCI EXPRESS Standard.

The GPU 105 is the display controller which controls the LCD 17 that is used as a display monitor of the computer 10. The GPU 105 generates a display signal, which is supplied to the LCD 17.

The south bridge 104 controls the devices provided on the peripheral component interconnect bus (PCI) and low pin count (LPC) bus, both extending in the computer 10. The south bridge 104 incorporates an integrated drive electronic (IDE) controller, which controls the HDD 109 and ODD 110. Further, the south bridge 104 includes the function of performing communication with the sound controller 106.

The sound controller 106 is a sound source device, and outputs audio data to the speakers 18A and 18B, which generate sound from the audio data. The LAN controller 108 is a wired communication device which executes wired communication of, for example, IEEE 802.3 Standards. By contrast, the wireless LAN controller 112 is a wireless communication device which executes wireless communication of, for example, IEEE 802.11g Standards. The USB controller 111A executes communication with an external device of, for example, USB 2.0 Standards, which is connected to it by the USB connector 19. The USB controller 111A is used to receive video data from a digital camera, for example. The card controller 111B executes writing data into, or reading data from, a memory card, such as a secure digital (SD) card (registered trademark), inserted in the card slot provided in the computer main unit 11.

The EC/KBC 113 is a one-chip microcomputer including an embedded controller and a keyboard controller. The embedded controller controls power, and the keyboard controller controls the keyboard 13 and touch pad 16. The EC/KBC 113 includes the function of turn the computer 10 on or off as the user operates the power button 14.

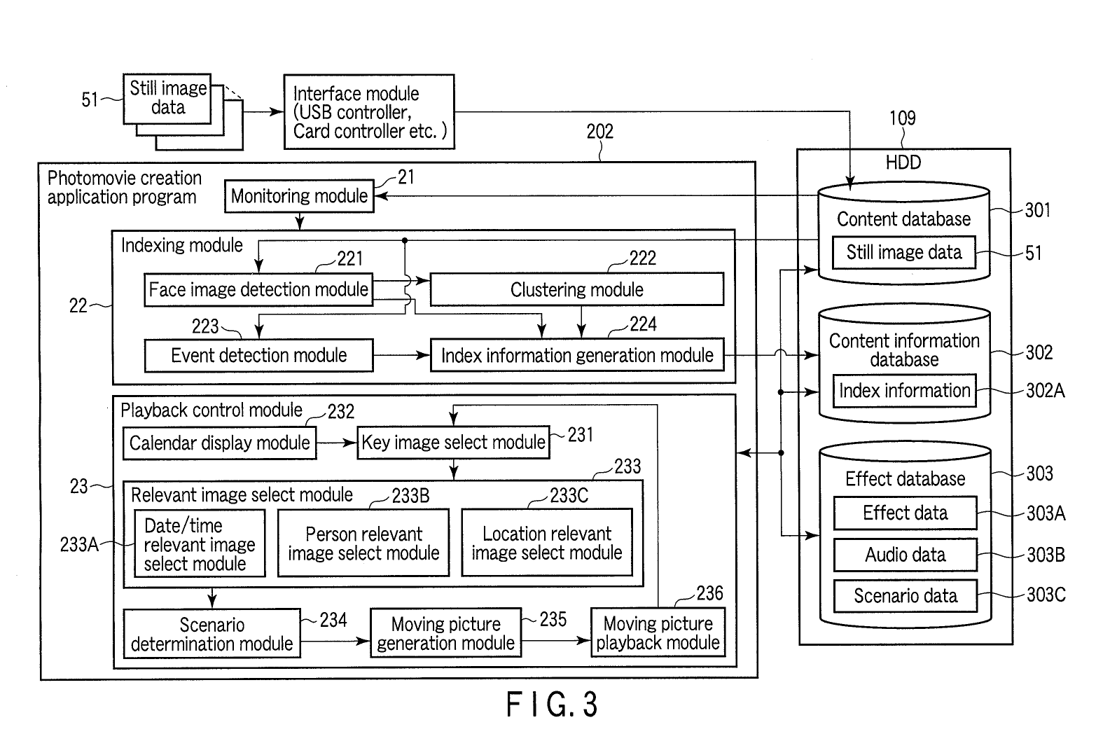

The function configuration of the photomovie creation application program 202 will be explained with reference to FIG. 3. Of the functions the photomovie creation application program 202 executes, the function of generating moving pictures will be described. This moving-picture generating function generates a moving picture (i.e., photomovie) or a slide show by using a plurality of still images stored in a prescribed directory (folder) provided in the HDD 109. The moving picture or slide show, thus generated, is played back. Still image data items 51 are digital photos or a still image file (e.g., JPEG file), for example. The term “photomovie” means a moving picture (movie) composed of a plurality of still images (e.g., photos). To play back the photomovie, various effects or transitions are applied to a still image group. The still image group, with effects or transitions applied, is played back together with music. The photomovie creating application program 202 can automatically extract a still picture group related to a particular still image (i.e., key image), can generate a photomovie from the still picture group, and can play back the photomovie so generated. The term “slide show” means a method of sequentially displaying still images, one by one. In the slide show, effects or transitions can be applied to each still image.

The photomovie creation application program 202 monitors a folder (i.e., photo folder) stored in the HDD 109 and designated by the user. On detecting one or more new still images (photo files) in the photo folder, the photomovie creation application program 202 starts performing indexing on the new still images and initiates, at the same time, the slide show, displaying the new still image, one by one. The user can enjoy the slide show, seeing the new still images, until the indexing is completed. That is, the user does not feel he or she is kept waiting until the indexing is completed. When the indexing is completed, the photomovie creation application program 202 generates a photomovie from one or more new still images. The photomovie generated is displayed. This satisfies the user who wants to view the new still images immediately. In this case, the photomovie may be generated from one or more new still images only, or from one or more new still images and still images extracted from the photo folder, which related to the one or more new still images. Furthermore, after the photomovie (first photomovie) has been generated from one or more new still images, the still images related to these new still images may be extracted from the photo folder, and another photomovie (second photomovie) may be generated from the new still images extracted from the photo folder and then displayed.

The user can therefore enjoy a slide show (seeing the new still images, one after another, which need not have index information), once the new still images have been stored into the photo folder in the electronic apparatus according to this embodiment. At the same time the slide show starts, the photomovie creation application program 202 starts executing indexing on the new still images. This does not make the user feel he or she is kept waiting for the completion of indexing. That is, as soon as the indexing is completed, a photomovie generated from the new still images is played back, and the user can immediately enjoy seeing the photomovie generated from the new still images. The configuration that starts executing various processes when new still image are stored into the photo folder will be described later in detail.

A photomovie is generated on the basis of one still image (key image) the user has selected. First, still images related to the key image are automatically extracted from the photo folder. Then, a photomovie is generated from the still images so extracted. As photo-movie generating conditions, a style, music, and a person of interest (face image) may be selected. The style selected determines the method of extracting still images from which to generate a photomovie and, also, the effects, transitions, etc., to be applied to the still images extracted. With the conventional electronic apparatus, the user designates still images from which to generate a movie. In the electronic apparatus according to this embodiment, the photomovie creation application program 202 automatically extracts still images from which to generate a photomovie. The resultant photomovie may therefore include photos that the user has not expected at all.

In the process of extracting still images, still images better than others in terms of the smile degree and sharpness of face images may be extracted from the photo folder. Further, the person of each face image may be recognized by executing face clustering, and photos each containing the face image of the person selected or photos each containing the face image of another person related to the person selected may be extracted from the photo folder. Moreover, an event-grouping technique may be utilized to classify the photos into groups each related to an event. In this case, the relevancy between any two events may be inferred from the relation between the persons participating in both events, and the result of inference may be used to extract some photos from the photo folders. For example, events in which the same person has participated may be inferred as relevant to each other. Further, for example, if Person A and Person B appear together in many photos (if coexistence frequency is high), the event in which Person A has participated can be inferred as relevant to the event in which Person B has participated.

The photo-movie generating application program 202 includes a monitoring module 21, an indexing module 22, and a playback control module 23.

The monitoring module 21 monitors the content database 301 provided in the HDD 109 at all times. Therefore, the monitoring module 21 determines whether or not new still image data items 51 have been stored into the content database 301 through an interface module such as the USB controller 111A or the card controller 111B. The content database 301 is equivalent to a prescribed directory (i.e., photo-folder mentioned above). The still image data items 51 stored in the content database 301 are used as content candidates for the moving picture (photomovie) and slide show. The content database 301 may store not only still images but also moving pictures as the content candidates for, for example, a short movie.

The indexing module 22 analyzes a plurality of still image data items 51 stored in the content database 301, and generates index information 302A representing the attributes of the respective still image data items 51. The indexing module 22 starts indexing, triggered by, for example, the storage of one or more still image (photo files) into the content database 301. That is, when one or more new still images are stored into the content database 301, the indexing module 22 generates index information about the new still images.

The indexing module 22 includes a face recognition function, too. The index information 302A includes the results of recognizing face images contained in the still image data items 51.

The indexing module 22 includes a face image detection module 221, a clustering module 222, an event detection module 223, and an index information generation module 224.

The face image detection module 221 extracts face images from the still image data items 51 that should be indexed (e.g., new still images stored into a photo folder). The face images can be detected by, for example, first analyzing the characteristics of the still image data items 51 and then searching for regions having characteristic similar to a face-image characteristic sample prepared before. The face-image characteristic sample is characteristic information that has been acquired by statistically processing the facial characteristics of many persons. In the process of extracting face characteristics, the regions corresponding to the face images contained in the still image data items 51 are detected, and the positions (coordinates) and sizes of these regions are also detected.

Further, the face image detection module 221 analyzes the face images thus extracted. The face image detection module 221 calculates the smile degree, sharpness, frontality, etc. of each face image extracted. The smile degree is an index that indicates how much the person smiled when photographed. The sharpness is an index that indicates how clear the face image is (that is, not blurred). The frontality is an index that indicates how much the person's face is directed toward the front. The information about the face images so analyzed is output from the face image detection module 221 to the clustering module 222.

The clustering module 222 executes clustering on the face images detected, thereby classifying the face images in accordance with the characteristic similarity. Any face images similar in characteristic are therefore recognized as pertaining to the same person. On the basis of the clustering results, the clustering module 222 assigns identification data items (personal IDs) to the face images. More precisely, a personal ID is assigned to the face images of one person. The clustering module 222 outputs the attributes of each face image (i.e., smile degree, sharpness, frontality, and personal ID) to the index information generation module 224.

The event detection module 223 detects an event associated with the still image data items 51 to be indexed. More specifically, in accordance with the dates and times (photographing dates and times) when the still images were acquired, the event detection module 223 classifies these still image data items 51 into groups, each consisting of still images acquired within a period (e.g., one day) and therefore regarded as photographed at an event. Then, the event detection module 223 assigns event identification data items (event IDs) to the still image data items 51 to be indexed. The event IDs, each assigned to still images acquire at the same event, are output from the event detection module 223 to the index information generation module 224.

The index information generation module 224 generates index information 302A from the data coming from the face image detection module 221, clustering module 222 and event detection module 223.

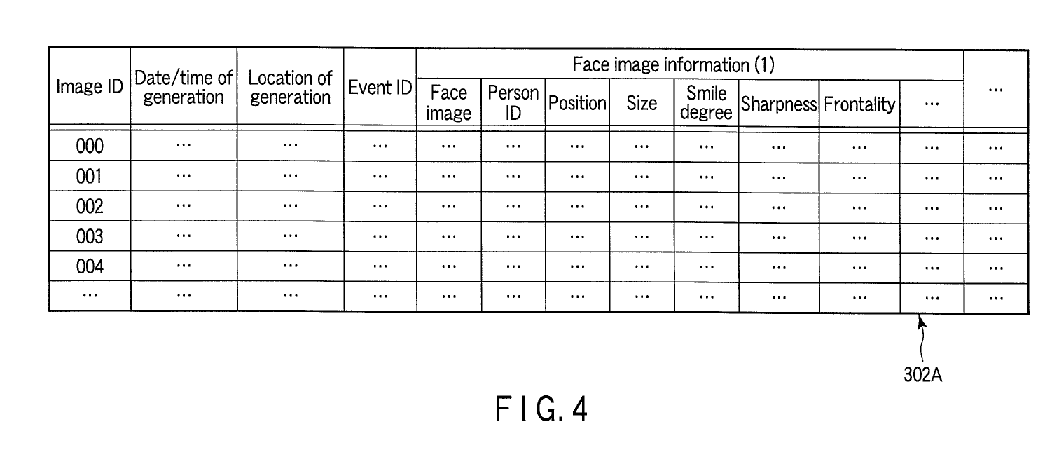

FIG. 4 shows exemplary index information 302A. Index information 302A contains entries corresponding to still image data items 51, respectively. Each entry includes, for example, image ID, date/time of generation (photographing date/time), location of generation (photographing location), event ID and face image information. Of the entry associated with a certain still image, the image ID is the identification data specific to the still image, the date/time of generation indicates the date and time when the still image was generated, and the location of generation indicates the location where the still image was generated. The date/time of generation and the location of generation are, for example, data items added to the still image data. The location of generation is data representing the position detected by, for example, a global positioning system (GPS) receiver detected when the still image data was generated (for example, when the photo corresponding to the still image data was taken). The event ID is the ID data uniquely assigned to the event associated with the still image. The face image information represents the result of recognizing the face images contained in the still image, and includes a face image (e.g., location data indicating the storage location of the face image), personal ID, position, size, smile degree, sharpness and frontality. One still image data item 51 may contain a plurality of face images. In this case, the Index information 302A associated with the still image data item 51 contains face image data items about the respective face images.

The index information generation module 224 stores the index information 302A into the content information database 302.

So configured as described above, the indexing module 22 generates index information 302A associated with the still image data input. The index information 302A can be stored in the content information database 302.

In accordance with the index information 302A, the playback control module 23 extracts a still image group associated with a still image (key image) selected, from the still image data items 51 stored in the content database 301. The still image group extracted is used, whereby a photomovie or a slide show is generated and played back. The playback control module 23 includes, for example, a key image select module 231, a calendar display module 232, a relevant image select module 233, a scenario determination module 234, a moving picture generation module 235, and a moving picture playback module 236.

The key image select module 231 selects a key image (key still image) from the still image data items 51 stored in the content database 301. The key image select module 231 can also select, as a key image, any still image included in the moving picture (i.e., photomovie) or slide show being played back. That is, the key image select module 231 selects, as a key image, one of the images constituting the photomovie or slide show being played back, which the user has designated. If the user designates no key images while the photomovie or slide show is being played back, the key image select module 231 may select, as a key image, the last still image included in the photomovie or slide show.

The key image select module 231 may select the key image, by using a calendar screen arranging the still image data items 51. That is, using the calendar screen, the key image select module 231 can select the still image the user has designated, as a key image.

Alternatively, the key image select module 231 can designate the face image the user has selected, as a key face image. In this case, the still image data items 51 associated with the person corresponding to the key face image are extracted from the content database 301 and used to generate a moving picture (a photomovie) or a slide show. The relevant image select module 233 selects (extracts) the still images relevant to the key image (key face image) from the still image data items 51 stored in the content database 301. The still images relevant to the key image are those that are relevant to, for example, date, time, person and location. The relevant image select module 233 extracts the still images relevant to the key image by using the index information 302A stored in the content information database 302, for example. The relevant image select module 233 includes a date/time relevant image select module 233A, a person relevant image select module 233B, and a location relevant image select module 233C.

The date/time relevant image select module 233A selects (extracts) the still images relevant to the data and time the key image was generated, from the still image data items 51 stored in the content database 301. On the basis of, for example, the index information 302A, the date/time relevant image select module 233A selects (extracts) the still images generated during the same period (for example, day, month, season or year) the key image was generated. The date/time relevant image select module 233A further selects (extracts), on the basis of the index information 302A, the still images generated during a period (day, month, season or year) different from the period the key image was generated (for example, on the same day or in the same month exactly one year before or after).

The person relevant image select module 233B selects (extracts) still images relevant to the key face image (i.e., face image contained in the key image) from the still image data items 51 stored in the content database 301. The still images relevant to the key face image are, for example, a still image containing the face image of the person identical to the key face image and a still image containing the face image of another person relevant to the person of the key face image. The other person relevant to the person of the key face image is, for example, a person whose face image appears in the still image containing the key face image.

The location relevant image select module 233C selects (extracts) the still images relevant to the location where the key image has been generated, from the still image data items 51 stored in the content database 301.

The scenario determination module 234 determines a scenario for the moving picture (e.g., photomovie) that should be generated. The scenario is information (scenario information) representing the effects and still image attributes that will be applied to the chapters (time segments) of the moving picture to be generated. In other words, the scenario defines both an effect and still image attribute for each time segment called “chapter.”

In this embodiment, 24 scenario information items, for example, are stored in an effect database 303 as scenario data 303C. The scenario determination module 234 determines one of the 24 scenario information items as a scenario that should be used to generate a moving picture (e.g., photomovie). The scenario to be used to generate a moving picture may be determined in accordance with the style the user has selected. That is, the scenario is determined in accordance with the style selected. Eight styles (Happy, Fantastic, Ceremonial, Cool, Travel, Party, Gallery and Biography), for example, are prepared in the present embodiment. Further, three scenario information items are prepared for each style. The scenario determination module 234 automatically selects one of the three scenario information items associated with the style the user has selected, and then determines the scenario information item, which has been automatically selected, as the scenario for the moving picture (e.g., photomovie) that should be generated. Moreover, the scenario determination module 234, not the user, may automatically select any one of the eight styles. In this case, the style to be used may be determined from, for example, the characterizing features (e.g., number of persons, i.e., face images, the smile degree, etc.) of the still image extracted by the relevant image select module 233.

As described above, one of the three scenario information items associated with the style selected is selected as the scenario for the moving picture (e.g., photomovie) that should be generated. In order to select this scenario, a random number, for example, may be utilized. If a random number is used, a different scenario can be used every time to generate a photomovie, even if the user selects the same style. The attributes of the still images used to generate a photomovie change in accordance with the scenario selected and used. Hence, the change of scenario, from one to another, can render it more possible that the user may enjoy seeing a moving image constituted by unexpected still images.

The scenario determination module 234 further determines the music to be applied to the photomovie. In this embodiment, the effect database 303 stores audio data 303B that represents many pieces of music. The scenario determination module 234 determines the music to be applied to the photomovie, in accordance with the style selected or with the characterizing features (e.g., number of persons, i.e., face images, the smile degree, etc.) of the still image extracted by the relevant image select module 233. The music to be applied to the photomovie may be designated by the user.

The moving picture generation module 235 generates a photomovie in accordance with the scenario information the scenario determination module 234 has determined. In order to generate the photomovie, the moving picture generation module 235 extracts at least one still image that agrees in attribute with the still images for the chapters represented by the scenario information. Then, the moving picture generation module 235 generates a photomovie, by allocating the still image, thus extracted, to each chapter.

The moving picture playback module 236 plays back the photomovie by applying the effect correspond to each chapter, which is designated by the scenario information, to the still images allocated to each chapter, using the effect data 303A stored in the effect database 303.

The scenario information determined may be used to determine the order in which to display still images in a slide show. In this case, the moving picture generation module 235 extracts at least one of the still images extracted by the relevant image select module 233, which agrees in attribute to the still images for each chapter represented by the scenario information. Then, the moving picture generation module 235 allocates at least one extracted still image to each chapter. Still images to be used in the slide show and the timing of displaying these still images in the slide show are thereby determined. Before starting the slide show, the effect data 303A may be used to apply effects to the still images.

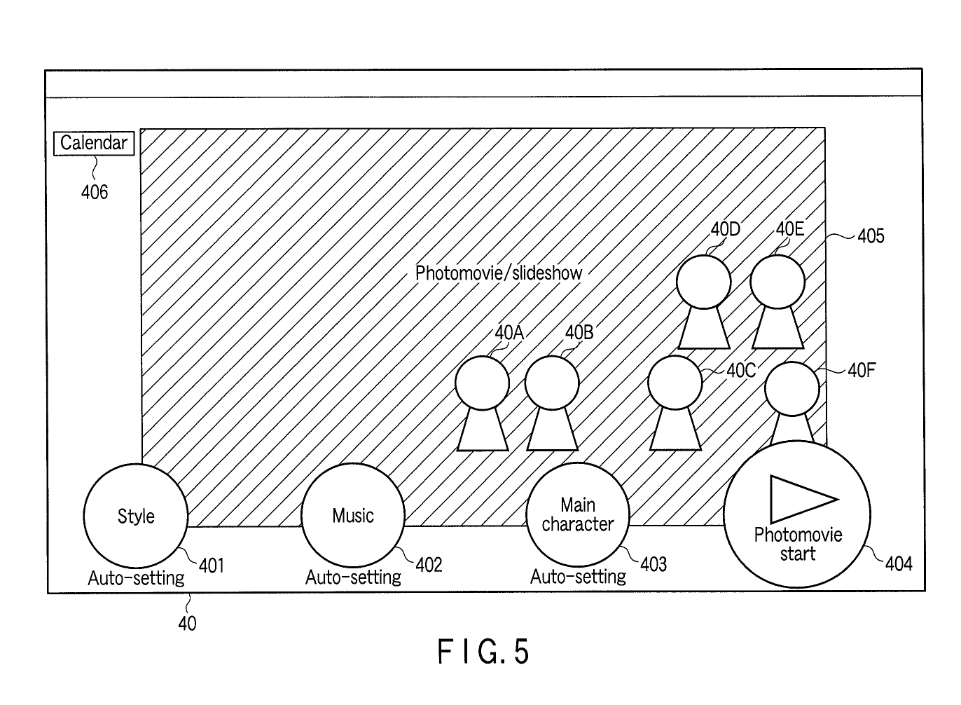

FIG. 5 shows an exemplary main menu screen 40 that may be displayed by using the photomovie creation application 202. The main menu screen 40 shows, for example, a “Style” button 401, a “Music” button 402, a “Main Character” button 403, a “Photomovie start” button 404, a movie playback screen 405, a “Calendar” button 406, and a “Setting” button 407.

The movie playback screen 405 is provided to show any photomovie or slide show that has been generated. On the movie playback screen 405, a photomovie or slide show generated by the playback control module 23 (more precisely, moving picture generation module 235) is played back. FIG. 5 shows a photomovie or a slide show, in which six persons 40A to 40F appear.

Assume the user operates a pointing device, clicking the movie playback screen 405, while a photomovie or a slide show is being played back. Then, the photomovie creation application 202 temporarily interrupts the photomovie (or slide show), and designates the image being played back, as a key image. If the image being played back has been generated by synthesizing a plurality of still images, the photomovie creation application 202 may determine one of these still images as a key image. Of these still images, the still image the user has clicked may, of course, be designated as a key image.

The “Main Character” button 403 is a button that should be clicked to select the main character, i.e., one of the persons appearing in the photomovie, who attracts more attention than any other persons. When the “Main Character” button 403 is clicked, the key image select module 231 displays a list of the persons appearing in the key image (i.e., face image selection screen) to the LCD 17. The user first selects the key image using the movie playback screen 405 and then pushes the “Main Character” button 403, instructing that a key face image should be selected.

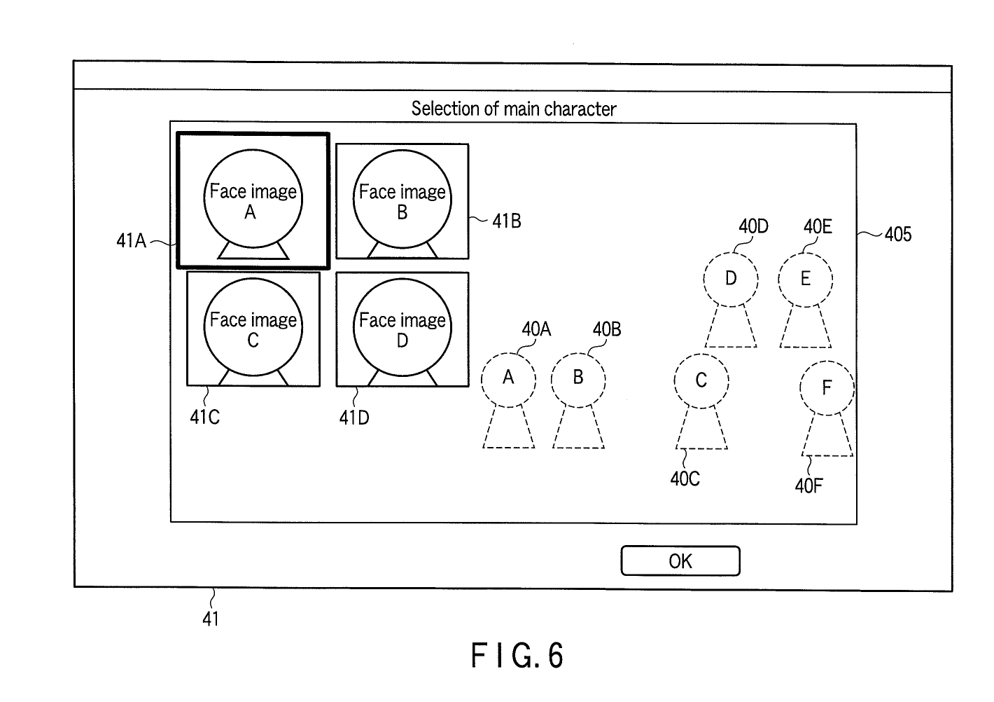

FIG. 6 shows an exemplary main-character selection screen 41 that may be displayed to enable the user to select a face image as a key face image. The main-character selection screen 41 displays a list of the face images (i.e., face images 41A to 41D) that are contained in the key image. The key image select module 231 first selects, from persons 40A to 40F, the persons (e.g., person 40A to 40D), each appearing in still images the number of which is equal to or greater than a threshold value. The key image select module 231 then displays the face images 401A to 41D of the persons 40A to 40D selected on the movie playback screen 405.

The user selects the face image of the person interesting to him or her, from the faces images 41A to 41D displayed on the main-character selection screen 41. The user may select, for example, face image 41A. In this case, the key image select module 231 determines the face image 41A as a key face image (main character). The user may select two or more face images at a time. If the user does not select any face images displayed on the main-character selection screen 41 (that is, if the “Main Character” button 403 is not pushed), the key image select module 231 may select, as a key face image, any one of the face images contained in the key image, which meets particular conditions.

The user may push the “Style” button 401 displayed on the main screen 40 of FIG. 5, in order to select a style for the photomovie. When the “Style” button 401 is pushed, the photomovie creation application 202 displays a style selection screen to the LCD 17. On the style selection screen, eight styles (Happy, Fantastic, Ceremonial, Cool, Travel, Party, Gallery and Biography) are displayed. The user can therefore select one of these styles.

The “Music” button 402 is a button the user may push to select music for the photomovie. When the “Music” button 402 is clicked, the photomovie creation application 202 displays a music list (music selection screen) to the LCD 17. The user can then select any music shown on the music selection screen.

The “Photomovie start” button 404 is a button the user may click to start the generation and playback of a photomovie. When the “Photomovie Start” button 404 is pushed, the photomovie creation application 202 starts generating a photomovie. The photomovie, generated, is displayed on the movie playback screen 405.

The key image select module 231 may use the calendar screen showing the still image data items 51 as described above, thereby selecting a key image. The “Calendar” button 406 is a button the user may push to display the calendar screen.

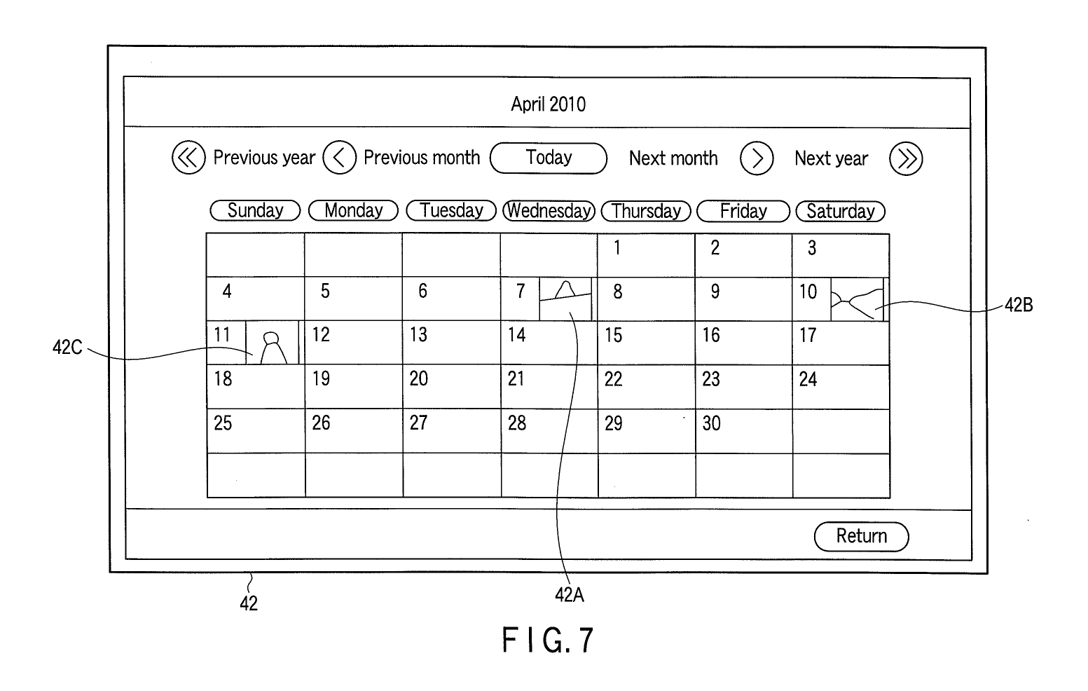

FIG. 7 shows an exemplary calendar screen 42 the LCD 17 may display. On the calendar screen 42, the calendar of the month designated is displayed. Thumbnail images (42A to 42C) are displayed, specifying the days on which still images were generated, respectively. The user may select one of the thumbnail images. Then, the key image select module 231 selects the still image for the thumbnail image selected, as the key image.

A plurality of still image data items 51 may be generated on the same day. In this case, the thumbnail image for one still image data item 51 is displayed, representing all still image data items 51. When this thumbnail image is selected on the calendar screen 42, the key image select module 231 displays a thumbnail list showing the thumbnail images generated on the day to the LCD 17. The user selects one of the thumbnail images in the thumbnail list. The key image select module 231 selects, as the key image, the still image data item 51 associated with the thumbnail image selected, from the thumbnail list. The key image select module 231 can use the main-character selection screen 41, too, to select a key face image after a key image is selected by using the calendar screen 42.

How the process of generating a photomovie proceeds will be explained. A photomovie is generated on the basis of a key image (i.e., image being displayed on the main menu screen 40 or an image selected at the calendar screen 42).

<Image Being Displayed on Screen 40 Is Used as Key Image>
(1) Click the main screen 40 while the slide show/photomovie is being played back.
(2) Select a style (default set to “Auto-setting”).
(3) Select the music for the photomovie (default set at “Auto-setting”).
(4) Select the person of interest (default set to “Auto-setting”).
(5) Click the “Photomovie start” button 404.

If the user wants to set a style, the music and the person of interest, all to “Auto-setting,” he or she only needs to click the main screen 40, displaying the “Photomovie start” button 404, and click the “Photomovie start” button 404.

<Image Selected at Calendar Screen is Used as Key Image>
(1) Click the “Calendar” button at the main screen 40.
(2) Select the date of photographing the basic photo, displaying a part of the photo.
(3) Select a basic photo from a photo list, and click the “Photomovie start” button 404.
(4) Select a style at the main screen 40 (default set to “Auto-setting”).
(5) Select the music for the photomovie at the main screen 40 (default set at “Auto-setting”).
(6) Select the person of interest (default set to “Auto-setting”).
(7) Click the “Photomovie start” button 404.

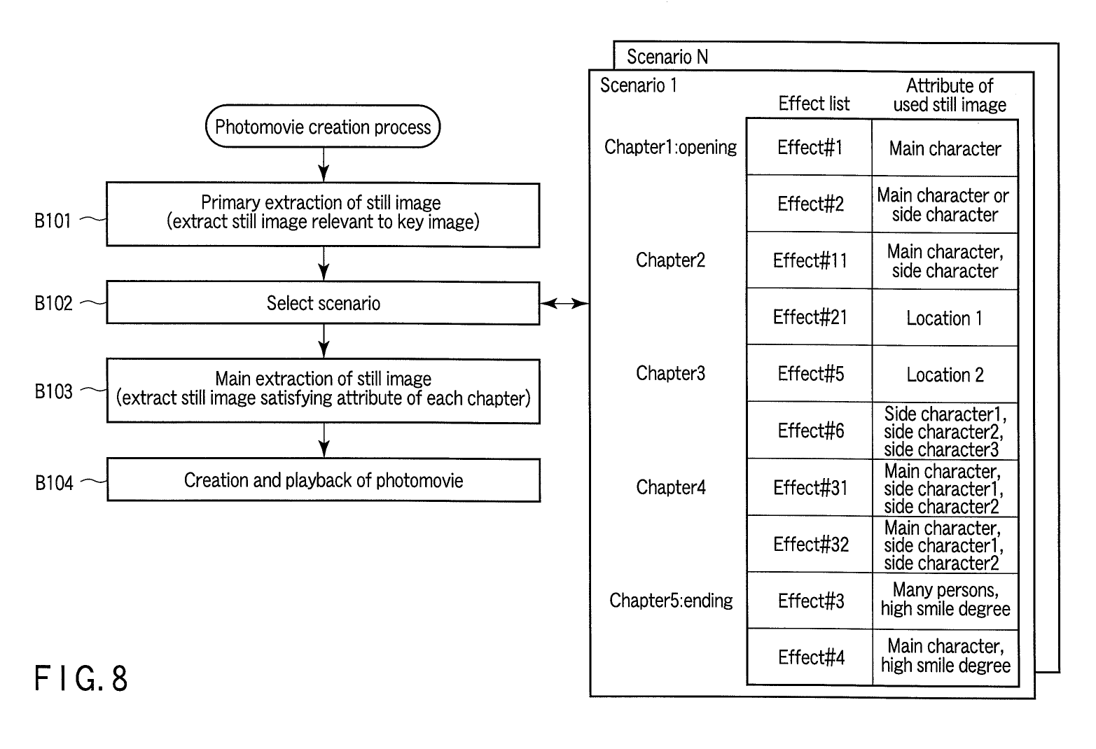

The process of generating a photomovie will be outlined below, with reference to FIG. 8.

First, the photomovie creation application 202 extracts the still images relevant to the key image (key face image) from the content database 301 (Primary extraction), in accordance with the index information (Block B101). The still images extracted by the photomovie creation application 202 in Block B101 from the content database 301 are, for example, those that are relevant to the person selected (i.e., main character).

Next, the photomovie creation application 202 selects a scenario for use in generating the photomovie (Block B102). In Block B102, the photomovie creation application 202 selects one of the scenario information items already prepared, in accordance with the style selected and the characteristic values of the still images extracted in Block B101. Each scenario information item defines the order (i.e., effect string) in which to use effects in the chapters (scenes) constituting a photomovie sequence, and also the attributes of the still images (i.e., still image attributes). The photomovie sequence shown in FIG. 8 is constituted by five chapters (i.e., chapters 1, 2, 3, 4 and 5). The chapter 1 is the opening scene of the photomovie.

The chapter 5 is the ending scene of the photomovie. For each chapter, one or more effects (two effects in the photomovie sequence shown in FIG. 8) are defined. Further, a still image attribute is defined for each effect.

As the attribute of each still image, the personal attribute of each person (i.e., face attribute) can be used. The personal attribute is, for example, main character, side character, smile degree, sharpness, and number of characters appearing in the still image. The term “main character” means the person who is the main character in the photomovie, i.e., person of interest (or face of interest). For example, the key face image mentioned above may be determined to be the main character. The term “side character” means another person who is related to the main character. For example, a person who often appears along with the main character in the photomovie may be determined to be the side character. The personal attribute can designate a plurality of support roles. That is, the persons (faces), who frequently appear along with the main character in the photomovie, can be side characters. Not only personal attributes, but also location attributes can be used as still image attributes. The location attributes designate the locations where the still images have been obtained.

The scenario 1 shown in FIG. 8 defines two effects (i.e., effect #1 and effect #2) for the chapter 1, and still image attributes “main character” and “main character OR side character” are associated with the effects #1 and #2, respectively. The still image attribute “main character” indicates that a still image in which the main character appears should be used. The still image attribute “main character OR side character” indicates that a still image in which either the main character or a side character should be used. Some other examples of still image attributes are as follows.

A still image attribute “main character, side character” associated with the effect #1 of the chapter 2, indicates that a still image should be used, in which both the main character and the side character appear. A still image attribute “side character 1, side character 2, side character 3” associated with the effect #6 of the chapter 3 indicates that a still image should be used, in which all three side characters 1, 2 and 3 appear. A still image attribute “many persons, high smile degree” associated with the effect #3 of the chapter 5 indicates that a still image should be used, in which persons as many as, or more persons than, a threshold value appear and having a smile degree equal to or higher than a threshold value. A still image attribute “main character, high smile degree” associated with the effect #4 of the chapter 5 indicates that a still image should be used, in which the main character appears and smiles at a level equal to or higher than a threshold value. Thus, the personal attributes can indicate whether each person to appear in any chapter is the main character, a side character, or both.

Thereafter, the photomovie creation application 202 extracts one or more still images having still image attributes designated by the scenario information (Main extraction), from the still images extracted in Block B101 (Block B103). The photomovie creation application 202 then allocates the still images, so extracted, to the chapters, thereby generating and displaying a photomovie (Block B104). More precisely, in Block B104, the photomovie creation application 202 applies various effects to the still image allocated to each chapter.

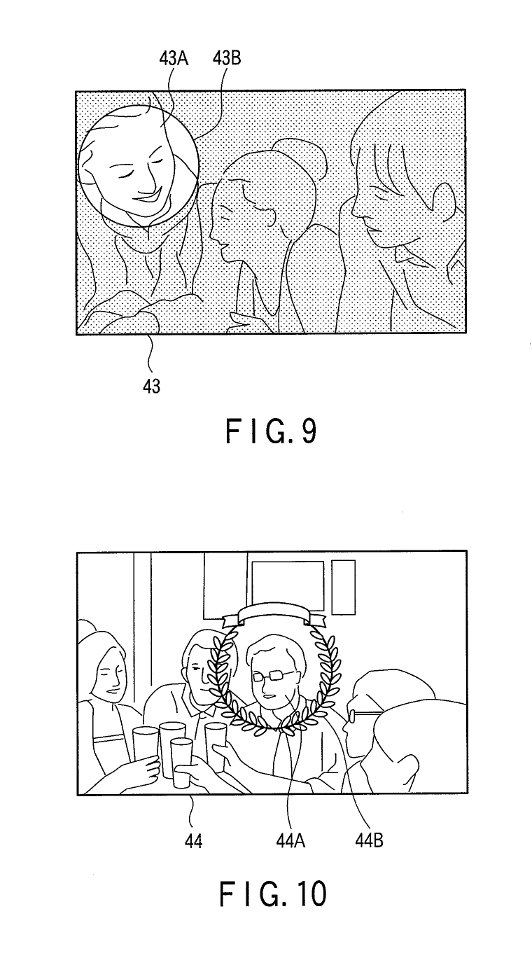

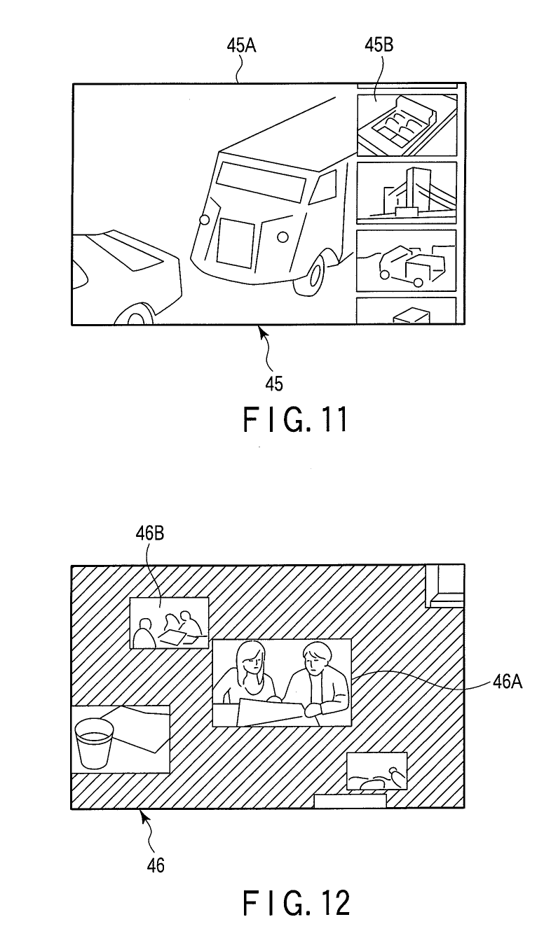

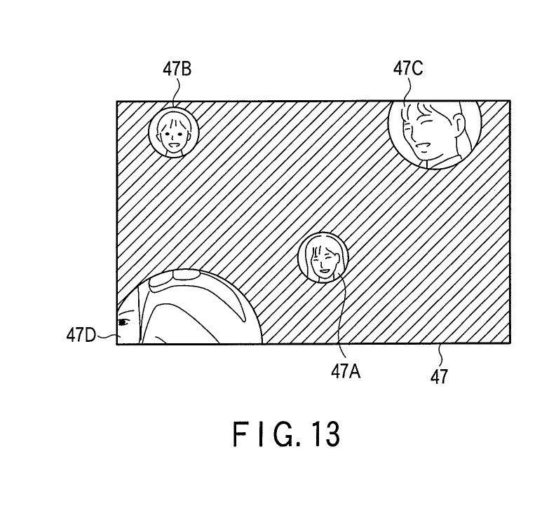

FIG. 9, FIG. 10, FIG. 11, FIG. 12 and FIG. 13 show several exemplary images that have some effects applied by the photomovie creation application 202.

FIG. 9 and FIG. 10 show two effects, respectively, which are applied to two still images, respectively, each effect emphasizing the face image of a particular person appearing in one still image. In the still image 43 of FIG. 9, effect 43B highlights the face image of a person 43A. Assume that in the still image 43, the person 43A is the main character, whereas the two other persons are side characters. Then, an effect can be applied to the still image, first highlighting “side character 1,” then highlighting “side character 2,” and finally highlighting “main character.” In the still image of FIG. 10, effect 44B, i.e., a wreath (object) is illustrated, surrounding the face image of person 44A.

FIG. 11 and FIG. 12 show screens 45 and 46, respectively, to which two effects are applied, respectively. In the still image 45 of FIG. 11 and the still image 46 of FIG. 12, small images 45B are arranged, representing the location, size, motion, etc. of the object 45A and 46A, respectively.

FIG. 13 shows a screen 47, respectively, to which an effect is applied. More precisely, face images 47A to 47D extracted from still images, respectively, are displayed on the screen 47, and keep moving on the screen 47.

How the various processes described above are performed every time a new still image is stored into a photo folder will be explained below in detail. Hereinafter, the new still images stored in the photo folder may be called “newly arrived images,” in some cases.

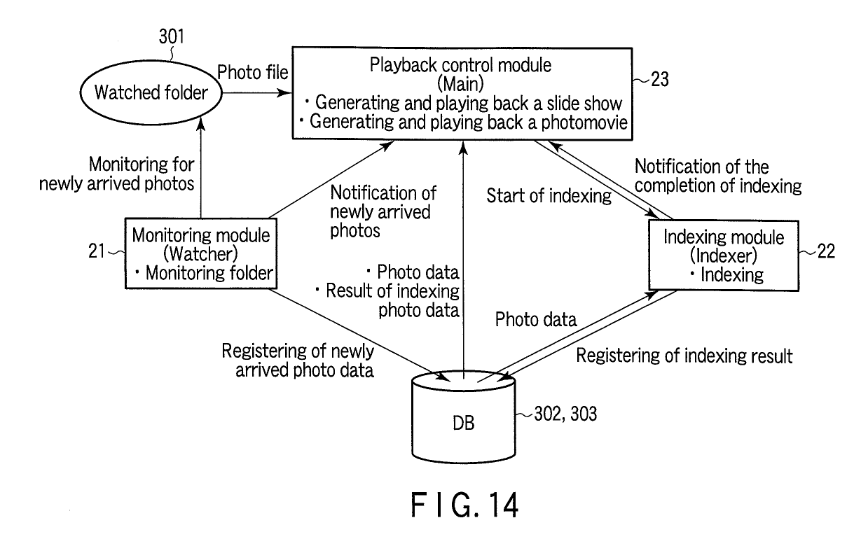

FIG. 14 is an exemplary block diagram showing the function configuration that the photomovie creation application 202 executes in connection with newly arrived images.

A “watched folder” shown in FIG. 14 is equivalent to the photo folder provided in the content database 301 and is kept watched for any newly arrived images. The playback control module 23 provides a user interface configured to set the “watched folder.” “DB” is equivalent to the content information database 302 holding index information 302A, and effect database 303 holding the effect data 303A, audio data 303B, scenario data 303C, etc.

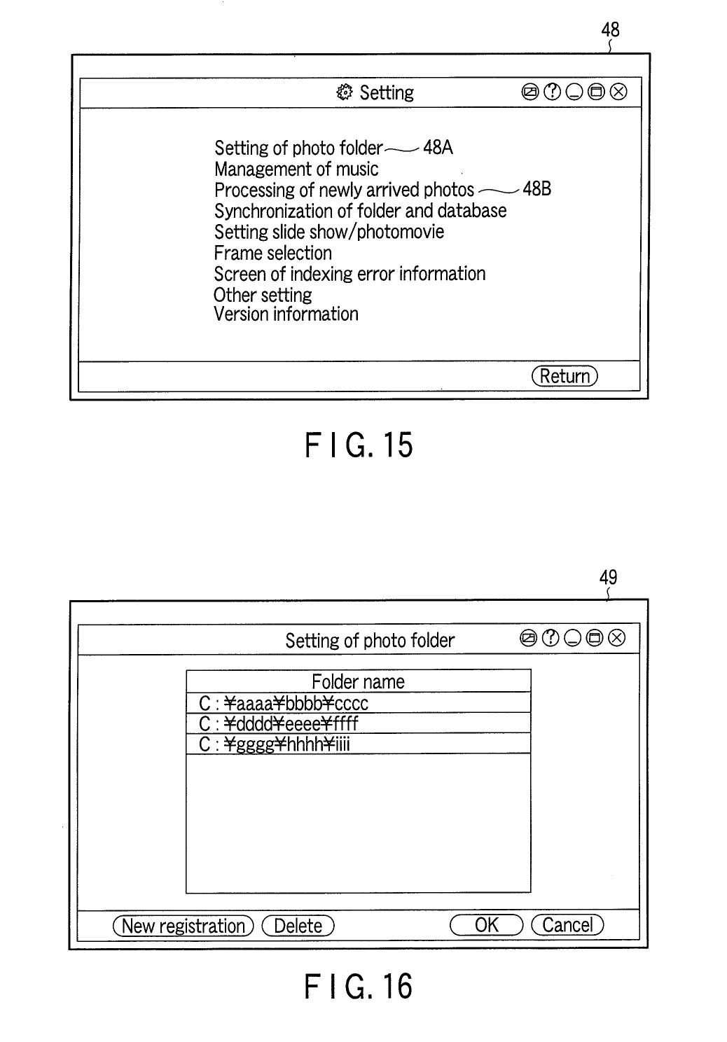

The user may click the “Setting” button 407 displayed on the main screen 40 of FIG. 5. Then, the playback control module 23 displays a setting screen 48 of FIG. 15 to the LCD 17. As shown in FIG. 15, there is a plurality of setting buttons including a “Photo folder setting” button 48A and a “Newly arrived image processing” button 48B. When the user clicks the “Photo folder setting” button 48A, the playback control module 23 displays a photo folder setting screen 49 of FIG. 16 to the LCD 17.

The user may set a photo folder (i.e., watched folder) he or she wants the monitoring module 21 to keep watching, on the photo folder setting screen 49. Note that a plurality of photo folders can be set. The monitoring module 21 watches the photo folder, determining whether the photo folder holds newly arrived photos. If a newly arrived photo is detected, the information of the newly arrived photo is registered in the content information database 302. To be more specific, the newly arrived photo is allocated to the vacant entry of the index information 302A shown in FIG. 4, and the image ID, generation data (photographing date) and generation location (photographing location) are stored in the content information database 302. After the content data has been stored in the content information database 302, the monitoring module 21 informs the playback control module 23 that the newly arrived image has been detected.

The monitoring module 21 detects not only the newly arrived photos stored in any photo folder set as a watched folder. It also detects, as newly arrived photos, the photos stored in any existing photo folder that has been set anew as a watched folder.

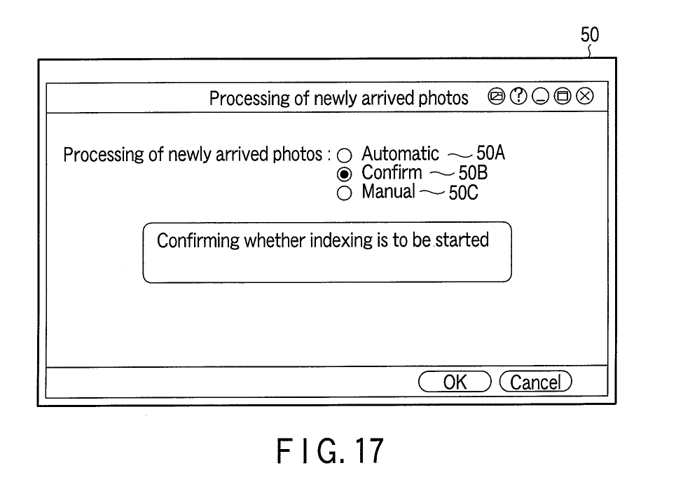

When informed that the newly arrived image has been detected, the playback control module 23 functions as a user interface for setting the sequence of operation. When the user clicks the “Newly arrived image processing” button 48B on the setting screen 48 shown in FIG. 15, the playback control module 23 displays a process menu screen 50 shown in FIG. 17 to the LCD 17, so that the newly arrived image may be processed.

As FIG. 17 shows, the process menu screen 50 shows an “Automatic” button 50A, a “Confirm” button 50B, and a “Manual” button 50C. These buttons 50A to 50C provided in the process menu screen 50 are radio buttons, only one of which can be clicked at a time.

The “Automatic” button 50A is a button for setting the operation of the indexing so that the indexing will be automatically started when newly arrived photos are detected.

The “Confirm” button 50B is a button for setting the operation of the indexing so that prompting the user to decide whether the indexing is to be started is executed if newly arrived photos are detected, and initiating the indexing is executed if the user instructs that the indexing be started. If the user does not instruct that the indexing be started, an object is displayed on the process menu screen 50, indicating that photos not indexed yet exist, and prompting the user to instruct the start of indexing. The “Manual” button 50C is a button for setting the operation of the indexing so that an object showing that photos not indexed yet exist and instructing indexing be started on these photos is displayed when newly arrived photos are detected.

Assume that the “Automatic” button 50A is clicked at the process menu screen 50. Then, upon receiving a notification about newly arrived photos from the monitoring module 21, the playback control module 23 instructs the indexing module 22 to start indexing the newly arrived photos at once. At the same time, the playback control module 23 starts a slide show of the newly arrived photos. This enables the user to view a slide show, only if the newly arrived photos are stored in the watched folder. Since the user can enjoy the slide show, seeing the newly arrived photos until the indexing is completed, there is no sense of being kept waiting until the indexing is completed.

Upon completing the indexing of the newly arrived photos, the indexing module 22 registers the indexing result (i.e., event ID and face image information) in the content information database 302, and then sends an indexing completion notification to the playback control module 23. On receiving this notification, the playback control module 23 generates a photomovie of the newly arrived photos by using the index information 302A, and then stops the slide show and starts displaying the photomovie thus generated to the LCD 17. Thus, the user can enjoy seeing the photomovie generated from the newly arrived photos, without performing any cumbersome operation. That is, the user can immediately see newly arrived photos in the form of a slide show or a photomovie. After the photomovie generated from the newly arrived photos has been displayed, a photomovie may be generated from all photos stored in the watched folder and may then be displayed at the LCD 17.

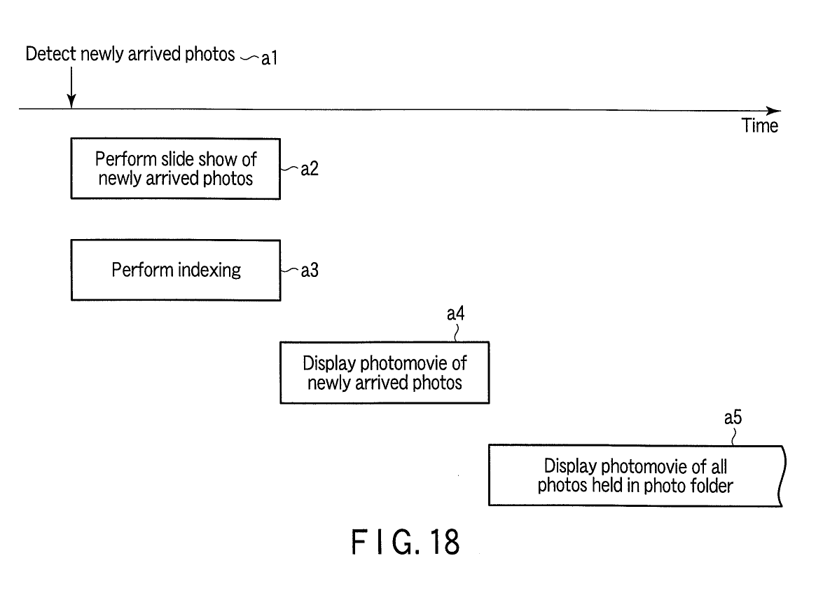

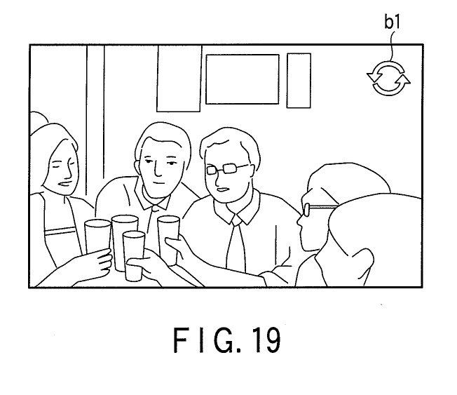

FIG. 18 is an exemplary timing chart showing when various processes are performed by the photomovie creation application 202 when new still images are stored into the photo folder.

On detecting newly arrived photos (a1 in FIG. 18), the photomovie creation application 202 starts a slide show of these photos (not requiring the index information 302A) if the “Automatic” button 50A has been selected (a2 in FIG. 18). At the same time, the photomovie creation application 202 starts executing indexing on the newly arrived photos (a3 in FIG. 18).

On completing this indexing, the photomovie creation application 202 stops the slide show of the newly arrived photos and starts a photomovie generated from the newly arrived photos (by using the index information 302A) (a4 in FIG. 18). The photomovie creation application 202 then starts a photomovie generated from all photos stored in the photo folder (a5 in FIG. 18).

The sequence of processes, described hitherto, is based on the assumption that the “Automatic” button 50A has been selected. Nonetheless, a slide show may be started when the indexing starts and a photomovie may then be started in the following three alternative cases:
(i) The “Confirm” button 50B has been selected, instructing that the indexing be started.
(ii) The “Confirm” button 50B has been selected, but not instructing that the indexing be started, and starting the indexing is instructed by using the object indicating that photos not indexed yet exist, and prompting the user to instruct the start of indexing.
(iii) The “Manual” button 50C has been selected, and starting the indexing is instructed by using the object indicating that photos not indexed yet exist, and prompting the user to instruct the start of indexing.

The playback control module 23 displays an object b1, as shown in FIG. 19, in each newly arrived photo being displayed in the slide show undergoing while the indexing module 22 is executing indexing. This object b1 informs the user that the indexing module 22 is executing indexing.

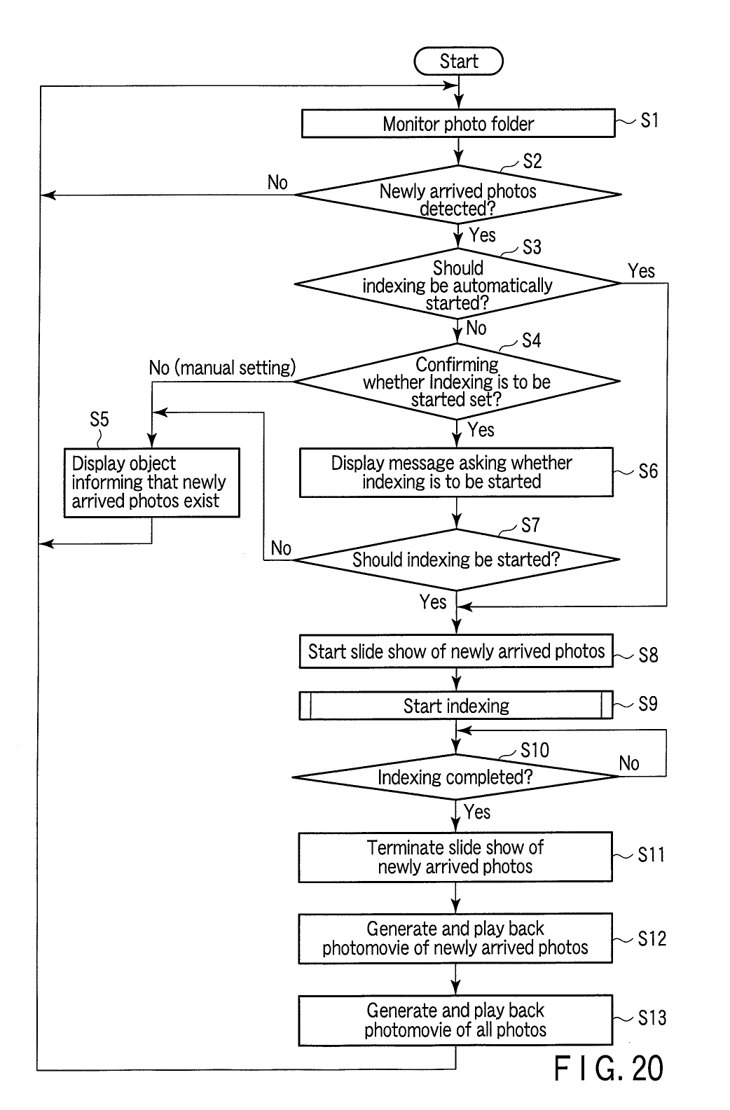

FIG. 20 is an exemplary flowchart showing an example of a process sequence the photomovie creation application 202 executes on any newly arrived photo.

The monitoring module 21 monitors the photo folder (Block S1), and determines whether new photos have arrived or not (Block S2). If newly arrived photos are detected (YES in Block S2), the monitoring module 21 notifies the playback control module 23 of the receipt of the newly arrived photos.

When so notified, the playback control module 23 starts a slide show of the newly arrived photos (Block S8) if “Automatic” had been set when the newly arrived photos were detected (YES in Block S3). At the same time, the playback control module 23 instructs the indexing module 22 to start indexing the newly arrived photos (Block S9). So instructed, the indexing module 22 starts indexing the newly arrived photos. On completing the indexing (YES in Block S10), the indexing module 22 notifies the playback control module 23 of the completion of indexing.

When so notified, the playback control module 23 terminates the slide show of the newly arrived photos (Block S11). Then, the playback control module 23 generates a photomovie from the newly arrived photos by using the index information 302A and plays back this photomovie (Block S12). Further, the playback control module 23 generates a photomovie from all photos stored in the photo folder and plays back this photomovie (Block S13).

If “Confirm” had been set when the newly arrived photos were detected (NO in Block S3, and YES in Block S4), the playback control module 23 displays a message, asking the user whether the indexing should be started (Block S6). If the user instructs that the indexing be started (YES in Block S7), the playback control module 23 executes the processes of Blocks S8 to S13. If the user does not instruct that the indexing be started (NO in Block S7), the playback control module 23 displays an object, informing the user that newly arrived photos exist, which have not been indexed yet (Block S5). The playback control module 23 executes this process (i.e., Block S5), too, if “Automatic” had been set when the newly arrived photos were detected. At the time this object is displayed (Block S5), instructing that the indexing be started, the playback control module 23 executes the processes of Blocks S8 to S13.

Thus, the electronic apparatus according to this embodiment monitors the watched folder, determining whether newly arrived photos exist in the watched folder. On detecting any newly arrived photo in the watched folder, the electronic apparatus starts indexing and, at the same time, starts a slide show of the newly arrived photos. After completing the indexing, the electronic apparatus immediately starts a photomovie of the newly arrived photos. The electronic apparatus does not need much time to generate a slide show or a photomovie from the newly arrived photos. That is, the electronic apparatus enables the user to view the slide show or the photomovie within a short time after acquiring the newly arrived photos.

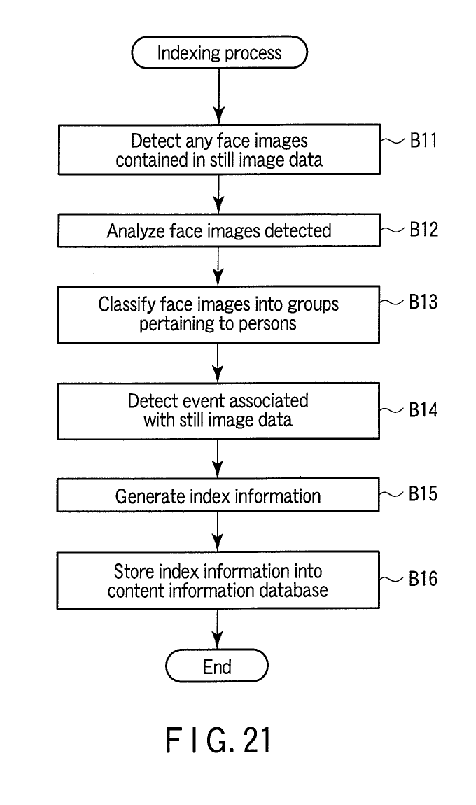

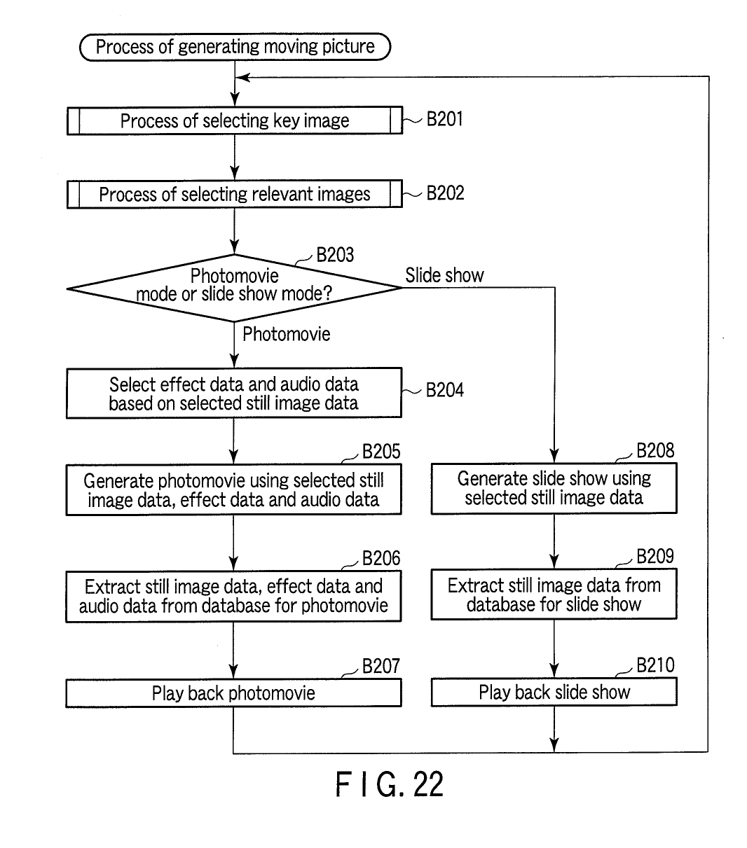

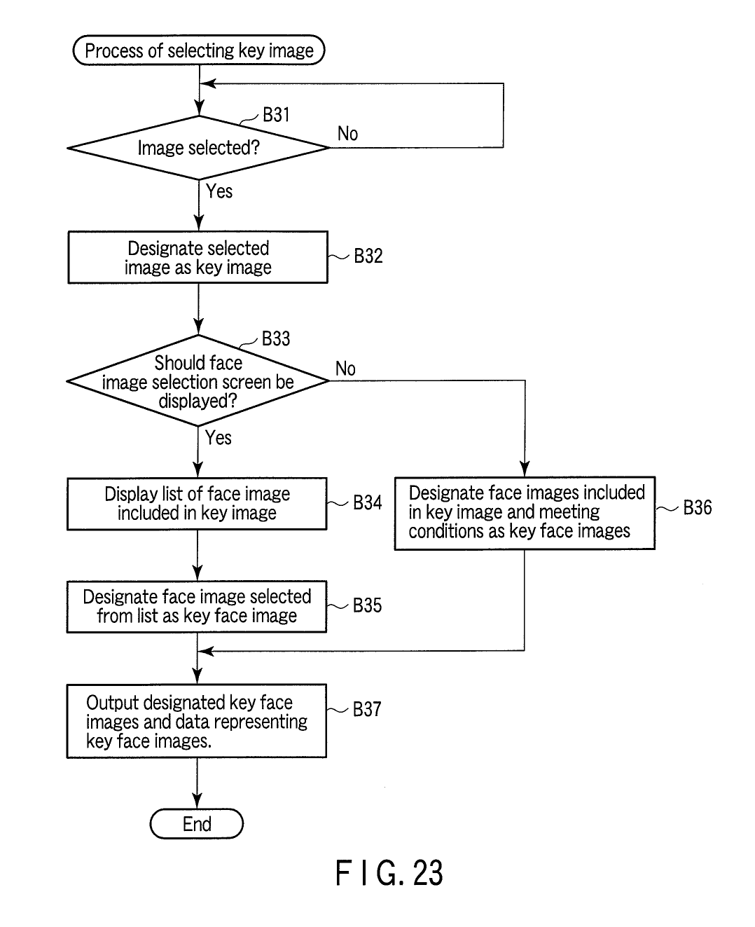

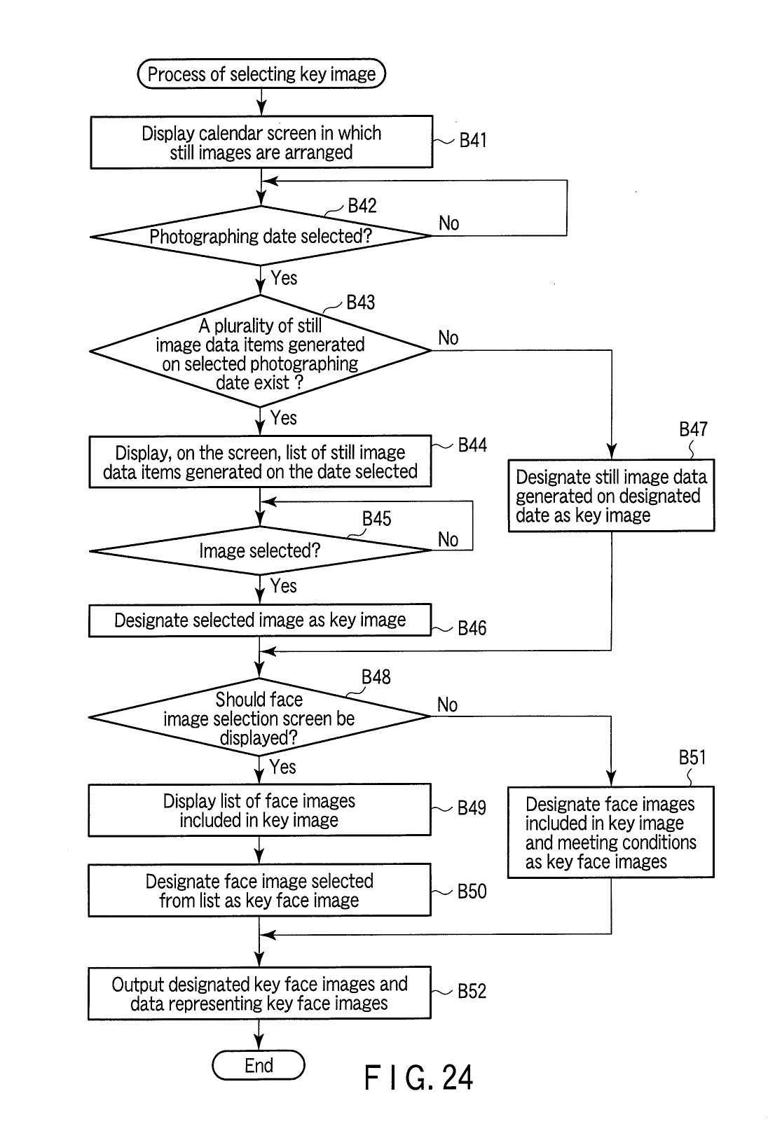

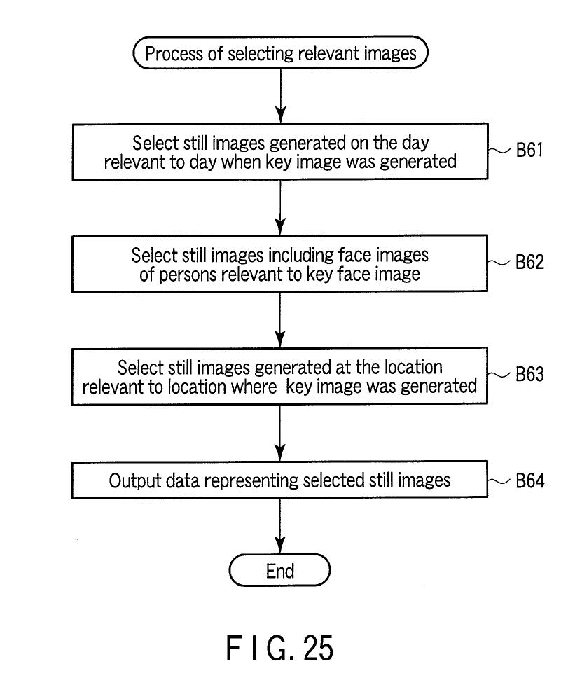

The operating sequence of the photomovie creation application 202 will be explained with reference to the flowcharts of FIG. 21, FIG. 22, FIG. 23, FIG. 24 and FIG. 25. First, the face image detection module 221 detects any face images contained in the still image data items 51 (Block B11). Then, the face image detection module 221 detects the regions corresponding to the face images of the persons appearing in the still images (represented by the still image data items 51), and also detects the locations and sizes of the face images. Next, the face image detection module 221 analyzes the face images it has detected (Block B12). Further, the face image detection module 221 calculates the smile degree, sharpness, frontality, etc. of each face image. The information representing the face images detected is output from the face image detection module 221 to the clustering module 222.

The clustering module 222 executes clustering on the face images detected by the face image detection module 221, classifying the face images into groups, each pertaining to one person (Block B13). The clustering module 222 then assigns identification data items (personal IDs) of the persons to the respective face images. Then, the clustering module 222 outputs the data items representing the face images detected by the face image detection module 221 and the personal IDs assigned to the face images, to the index information generation module 224.

The event detection module 223 detects the event associated with the still image data items 51 (Block B14). The event detection module 223 assigns the identification data (event ID) of the event detected, to the still image data items 51. The event ID assigned to the still image data items 51 is output from the event detection module 223 to the index information generation module 224.

The index information generation module 224 generates index information 302A from the results of the processes executed in the face image detection module 221 and clustering module 222 (Block B15). The index information 302A includes generation date/time, generation location and event ID of the still image data items 51, and face image information indicating a face image containing the still image data items 51. The face image information also contains a face image (storage location of the data representing the face image), personal ID, location, size, smile degree, sharpness and frontality. If any still image contains a plurality of face images, the index information 302A will include a plurality of face image data items representing these face images. The index information generation module 224 stores the index information 302A into the content information database 302 (Block B16).

Thus, the still image data items 51 input by the photomovie creation application 202 are stored into the content database 301, and the index information 302A associated with the still image data items 51 is stored into the content information database 302.

FIG. 22 is an exemplary flowchart showing an example of sequence of the moving-picture generating process executed by the photomovie creation application 202. The photomovie creation application 202 plays back either a photomovie or a slide show.

First, the key image select module 231 executes a key-image selecting process (Block B201). More precisely, the key image select module 231 selects a key image from the still image data items 51 stored in the content database 301. The key image so selected will be used as an extraction key for extracting the still images data items 51 from which to generate a moving picture (photomovie or slide show) that should be played back. The key image select module 231 outputs the data representing the key image to the relevant image select module 233. How the key image is selected will be explained later in detail, with reference to FIG. 23 and FIG. 24.

Next, the relevant image select module 233 executes a related image selecting process, by using the key image selected by the key image select module 231 (Block B202). That is, the relevant image select module 233 selects still image data items 51 relevant to the key image, from the content database 301. The still image data items 51 relevant to the key image are those that are relevant to the key image in terms of, for example, data/time, person or location. The still image data items 51 relevant to the key image are output from the relevant image select module 233 to the scenario determination module 234. The sequence of the relevant image selecting process will be explained later in detail, with reference to FIG. 25.

The scenario determination module 234 determines whether the display mode is photomovie mode or slide show mode (Block B203). The display mode indicates which type of a moving picture should be played back, a photomovie or a slide show. The display mode can be switched by the user. Alternatively, a moving picture linked to a preset display mode may be automatically played back. Still alternatively, the display mode may be switched in accordance with specific conditions.

If the display mode is found to be photomovie mode (“Photomovie” in Block 203), the scenario determination module 234 selects the effect data 303A and audio data 303B in accordance with the still image data items 51 selected by the relevant image select module 233 (Block B204). That is, the scenario determination module 234 selects the effect data 303A and the audio data 303B, which are appropriate for the still image data items 51 selected. The scenario determination module 234 outputs the still image data items 51, effect data 303A and audio data 303B, all selected, to the moving picture generation module 235.

The moving picture generation module 235 uses the still image data items 51 selected by the relevant image select module 233, and the effect data 303A (scenario data 303C) and audio data 303B selected by the scenario determination module 234, thereby generating a photomovie (Block B205). The photomovie so generated is output from the moving picture generation module 235 to the moving picture playback module 236.

In accordance with the photomovie generated by the moving picture generation module 235, the moving picture playback module 236 extracts the still image data items 51 from which to generate a photomovie, from the content database 301, and also the effect data 303A and audio data 303B, both to be used in the photomovie, from the effect database 303 (Block B206). Using the still image data items 51, effect data 303A and audio data 303B extracted, the moving picture playback module 236 plays back the photomovie to display it at the LCD 17 (Block B207). The operation then returns to the process of selecting the key image (Block B201). In Block B201, the key image select module 231 selects, as a new key image, one of the still image data items 51 from the photomovie being displayed, for example.

If the display mode is found to be the slide show mode (“Slide show” in Block 203), the moving picture generation module 235 generates a slide show, by using the still image data items 51 selected by the relevant image select module 233 (Block B208). The slide show, thus generated, is output from the relevant image select module 233 to the moving picture playback module 236.

In accordance with the slide show generated by the moving picture generation module 235, the moving picture playback module 236 extracts the still image data items 51 from which to generate a slide show, from the content database 301 (Block B209). Using the still image data items 51, the moving picture playback module 236 plays back the slide show and displays the slide show to the LCD 17 (Block B210). In the slide show, the still image data items 51 are sequentially displayed at prescribed intervals. The operation then returns to the process of selecting the key image (Block B201). In Block B201, the key image select module 231 selects, as a new key image, one of the still image data items 51 from the slide show being displayed, for example.

As the above-mentioned processes are performed, the photomovie creation application 202 can display a slide show or a photomovie, either using the still image data items 51 relevant to the key image. The use of the still image data items 51 relevant to the key image can provide the user with a moving picture that contains unexpected still images, etc.

The flowchart of FIG. 23 shows an exemplary sequence of the key-image selecting process (Block B201) performed by the key image select module 231. Assume that a key image is selected from the moving picture (photomovie or slide show) being displayed on the screen of the LCD 17.

First, the key image select module 231 determines whether an image has been selected from the moving picture being displayed (Block B31). If any image in the moving picture is found to have been clicked, the key image select module 231 determines that the image clicked has been selected as a key image. If no images are selected (NO in Block B31), the process returns to Block B31, in which the key image select module 231 determines again whether an image has been selected. If an image is selected (YES in Block B31), the key image select module 231 designates this image as a key image (Block B32).

Next, the key image select module 231 determines whether the main-character selection screen 41 should be displayed or not (Block 33). When a button is pushed, instructing the displaying of the main-character selection screen 41, the key image select module 231 determines that the main-character selection screen 41 should be displayed. When a button is pushed, instructing the selection of a key image, the key image select module 231 determines that the main-character selection screen 41 should not be displayed.

If it is determined that the main-character selection screen 41 should be displayed (YES in Block B33), the key image select module 231 displays the main-character selection screen 41 (Block B34). The main-character selection screen 41 is, for example, a screen that displays a face image list showing the face images contained in the key image selected. The user selects the face image of the person of interest (main character) from the face image list. The key image select module 231 then designates the face image selected at the main-character selection screen 41 (from the face image list), as a key face image (Block B35). A plurality of face images may be selected, not only one face image, at the main-character selection screen 41.

It may be determined that the main-character selection screen 41 should not be displayed (NO in Block B33). In this case, the key image select module 231 designates all face images contained in the key image, as key face images (Block B36). The key image select module 231 may select those of the face images contained in the key image, which meet various conditions such as location, size and sharpness, and may then designate these face images as key face images.

After selecting a key face image in Block S35 or in Block B36, the key image select module 231 outputs the data representing the key image and the key face images to the relevant image select module 233 (Block B37).

Thus, the key image select module 231 uses not only the moving picture (photomovie) or the slide show being played back, but also the main-character selection screen 41, thereby to select the key image and the key face image, in accordance with which still image data items 51 are extracted. The relevant image select module 233 selects, from the content database 301, still image data items 51 relevant to the key image and key face image based on the selected key image and key face image.

The flowchart of FIG. 24 shows another exemplary sequence of the key-image selecting process that the key image select module 231 performs (Block 201 shown in FIG. 22). Assume that the calendar screen 42 is used to select a key image.

At first, the calendar display module 232 displays the calendar screen 42, in which the still image data items 51 are arranged in the order they have been generated (Block B41). For example, the calendar display module 232 displays thumbnail images at the dates displayed on the calendar screen 42. Each thumbnail image shows the date of photographing the associated still image. If two or more still image data items 51 have the same photographing date, the calendar display module 232 displays only one thumbnail image (representative thumbnail image) for these still data items 15. The user may select any one of the thumbnail images displayed on the calendar screen 42, thereby to designate the date of photographing the associated still image or images.

Next, the calendar display module 232 determines whether a photographing date has been selected or not (Block B42). For example, the calendar display module 232 determines that a photographing date is selected when the data is clicked on the calendar screen 42. If no photographing dates have been selected (NO in Block B42), the process returns to Block B42, in which the calendar display module 232 determines again whether a photographing date has been selected or not.

If a photographing date has been selected (YES in Block B42), the calendar display module 232 determines whether a plurality of still image data items 51 have been generated on the selected photographing date (Block B43). If a plurality of still image data items 51 have been generated on the selected photographing date (YES in Block B43), the calendar display module 232 displays, on the screen, a list of the thumbnail images associated with these still image data items 51 (Block B44). The calendar display module 232 then determines whether a thumbnail image has been selected from the list displayed (Block B45). If no thumbnail images have been selected from the list (NO in Block B45), Block B45 is repeated, wherein the calendar display module 232 determines again whether a thumbnail image has been selected from the list displayed. If a thumbnail image has been selected from the list (YES in Block B45), the key image select module 231 designates the selected thumbnail image as a key image (Block B46).

If a plurality of still image data items 51 were not generated on the selected date (that is, if only one still image data item 51 was generated on that date) (NO in Block B43), the key image select module 231 designates the sole still mage data item 51 generated on that date, as a key image (Block B47).

After selecting a key image in Block B46 or Block B47, the key image select module 231 determines whether the main-character selection screen 41 should be displayed or not (Block B48). For example, when a button is pushed, instructing the displaying of the main-character selection screen 41, the key image select module 231 determines that the main-character selection screen 41 should be displayed. For example, when a button is pushed, instructing the selection of a key image, the key image select module 231 determines that main-character selection screen 41 should not be displayed.

On determining that the main-character selection screen 41 should be displayed (YES in Block B48), the key image select module 231 displays the main-character selection screen 41 (Block B49). The main-character selection screen 41 is, for example, a screen that displays a face image list showing the face images contained in the key image selected. The user selects the face image of the person of interest (main character) from the face image list. The key image select module 231 then designates the face image selected at the main-character selection screen 41 (from the face image list), as a key face image (Block B50). A plurality of face images may be selected, not only one face image, at the main-character selection screen 41.

It may be determined that the main-character selection screen 41 should not be displayed (NO in Block B48). In this case, the key image select module 231 designates, as key face images, those of the face images contained in the key image, which meet prescribed conditions (Block B51). For example, the key image select module 231 may select those of the face images contained in the key image, which meet various conditions such as location, size and sharpness, and may then designate these face images as key face images.

After selecting a key face image in Block B50 or in Block B51, the key image select module 231 outputs the data representing the key image and the key face images to the relevant image select module 233 (Block B52).

Thus, the key image select module 231 uses the calendar screen 42 and main-character selection screen 41, thereby to select the key image and key face image, in accordance with which still image data items 51 are extracted. The relevant image select module 233 selects, from the content database 301, still image data items 51 relevant to the key image and key face image based on the selected key image and key face image. Note that the key image may be selected not only from the moving picture or the calendar screen 42, but also from the list of the still image data items 51 stored in the content database 301.

FIG. 25 is an exemplary flowchart showing an example of sequence of the related image selecting process that the relevant image select module 233 executes.

First, the date/time relevant image select module 233A selects, from the content database 30, the still image data items 51 generated on the date when the key image was generated (Block B61). Next, the person relevant image select module 233B selects still image data items 51 including data representing the face images relevant to the key face image (Block B62). Then, the location relevant image select module 233C selects the still image data items 51 relevant to the location where the key image has been generated, from the still image data items 51 stored in the content database 301 (Block B63).

The still image data items 15 selected by the date/time relevant image select module 233A, person relevant image select module 233B and location relevant image select module 233C are output from the relevant image select module 233 to the scenario determination module 234 (Block B64).

Thus, the relevant image select module 233 selects the still image data items 51 relevant to the key image and key face image. The moving picture generation module 235 generating a moving picture (photomovie) or a slide show, by using the selected still image data items 51.

As has been described, this embodiment enables the user to view a slide show or a photomovie, either generated from newly arrived photos, both easily and immediately, once the newly arrived photos have been stored into a photo folder designated as a watched folder.

The sequence of image displaying processes is achieved by software in the present embodiment. Hence, a computer of an ordinary type can easily achieve the same advantage as this embodiment, only if the program for performing this sequence is installed into the computer via a computer-readable storage media holding the program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
an indexer configured to generate index information with respect to one or more first still images in a storage area;
a photomovie processor configured to generate a first photomovie comprising the one or more first still images based on the index information, and to display the generated photomovie; and
an indexing controller configured to monitor the storage area to detect whether one or more new still images are added and, when one or more new still images are detected, to cause the photomovie processor to display the one or more new still images one after another, in a slideshow, and further configured to cause the indexer to generate index information with respect to the one or more new still images.

2. The apparatus of claim 1, wherein the indexing controller is configured to cause the photomovie processor to terminate the slide show when the indexer completes generation of the index information with respect to the one or more new still images.

3. The apparatus of claim 2, wherein the indexing controller is configured to cause the photomovie processor to generate a second photomovie comprising the one or more new still images, and to display the generated second photomovie, when the photomovie processor terminates the slide show.

4. The apparatus of claim 3, wherein the indexing controller is configured to cause the photomovie processor to generate a third photomovie comprising the one or more first still images and the one or more new still images, and to display the generated third photomovie, when the second photomovie is finished.

5. The apparatus of claim 1, wherein the indexing controller is configured to display a message seeking input indicative of whether the index information should be generated when one or more new still images are added to the storage area, and to cause the indexer to generate the index information with respect to the one or more new still images when it receives input indicating that the index information should be generated.

6. The apparatus of claim 1, further comprising a user interface module configured to set a first mode indicating whether the indexer should generate the indexing information automatically when one or more new still images are added to the storage area.

7. The apparatus of claim 6, wherein the indexing controller is configured to display a message seeking input indicative of whether the index information should be generated when the first mode is not set and when one or more new still image are added to the storage area, and to cause the indexer to generate the index information when it receives input indicating that the index information should be generated.

8. The apparatus of claim 6, wherein:
the user interface module is configured to designate at least one storage area where one or more still images are stored; and
wherein the indexing controller is configured to monitor whether new still images are stored into the at least one storage area designated by the user interface module and whether new storage areas are designated by the user interface module.

9. The apparatus of claim 1, wherein the indexing controller is configured to display an object on the still images displayed in the slide show while the indexer is generating the index information, the object indicating that the index information is being generated.

10. An indexing control method of an electronic apparatus comprising an indexer configured to generate index information with respect to one or more first still images in a storage area and a photomovie processor configured to generate a photomovie comprising the one or more first still images based on the index information, and to display the generated photomovie, the method comprising:
monitoring whether one or more new still images are added to the storage area;
displaying, with the photomovie processor, the one or more new still images one after another, in a slideshow; and
generating, with the indexer, the index information with respect to the one or more new still images, when the one or more new still images are added to the storage area.

11. The method of claim 10, further comprising terminating the slide show when the indexer completes generation of the index information.

12. The method of claim 11, further comprising:
generating, with the photomovie processor, a second photomovie comprising the one or more new still images; and
displaying the generated second photomovie, when the slide show is terminated.

13. The method of claim 12, further comprising:
generating, with the photomovie processor, a third photomovie comprising the one or more first still images and the one or more new still images; and
displaying the generated third photomovie, when the second photomovie is finished.

14. The method of claim 10, further comprising displaying a message seeking input indicative of whether the index information should be generated when one or more new still images are added to the storage area.

15. The method of claim 10, further comprising setting a first mode indicating whether the indexer should generate the indexing information automatically when one or more new still images are added to the storage area.

16. The method of claim 15, further comprising displaying a message seeking input indicative of whether the index information should be generated when is the first mode is not set and when one or more new still images are added to the storage area.

17. The method of claim 15, further comprising:
designating at least one storage area where one or more still images are stored,
wherein monitoring further comprises monitoring whether one or more new still images are stored into the at least one storage area designated and whether new storage areas are designated.

18. The method of claim 10, further comprising displaying an object on the still images displayed in the slide show while the indexer is generating the index information, the object indicating that the index information is being generated.
